(19) United States
(12) Patent Application Publication
(10) Pub. No.: US 2016/0290545 A1
(43) Pub. Date: Oct. 6, 2016

(54) HEATABLE HOLLOW BODY

(71) Applicant: CONTITECH AG, Hannover (DE)

(72) Inventors: Stefan Sostmann, Langenhagen (DE); Corinna Lorenz, Braunschweig (DE); Steffen Wietzke, Lehrte (DE); Frank Jungrichter, Korbach (DE); Harald Koch, Frankenau-Alten Lotheim (DE); Alexej Grib, Twistetal (DE); Wolfram Herrmann, Wunstorf (DE)

(73) Assignee: ContiTech AG, Hannover (DE)

(21) Appl. No.: 15/035,578

(22) PCT Filed: Aug. 22, 2014
(86) PCT No.: PCT/EP2014/067883

§ 371 Date: May 10, 2016

(30) Foreign Application Priority Data
Nov. 22, 2013 (DE) 10 2013 223 910.6

(51) Int. Cl. F16L 53/00

(52) U.S. Cl. CPC F16L 53/008

(57) ABSTRACT

A heatable hollow body for transporting and/or storing liquid, gaseous and/or pasty media, having at least one heatable layer which has an electrically conductive material, is provided, wherein the heatable layer is in direct contact at least partially, preferably largely, particularly preferably fully, with the medium to be heated. In some aspects, the electrically conductive material has such a high electrical resistance that it can heat the heatable layer as a resistance conductor, and the electrically conductive material has such a low electrical resistance that the heatable layer is simultaneously electrically conductive. In some cases, the heatable layer has an elastomeric material or a plastics material in which the electrically conductive material is embedded. Also, the electrically conductive material may be conductive carbon black, a metal powder or carbon nanotubes.

### CROSS REFERENCE TO RELATED APPLICATIONS

This application is a continuation application of international patent application PCT/EP2014/067883, filed Aug. 22, 2014, designating the United States and claiming priority from German patent application 10 2013 223 910.6, filed Nov. 22, 2013, and the entire content of these applications is incorporated herein by reference.

### FIELD OF THE INVENTION

The invention relates to a heatable hollow body for transporting and/or storing liquid, gaseous and/or pasty media, and to a system having such a heatable hollow body.

### BACKGROUND

This section provides background information to facilitate a better understanding of the various aspects of the disclosure. It should be understood that the statements in this section of this document are to be read in this light, and not as admissions of prior art.

In the field of hollow bodies for transporting and/or storing liquid, gaseous or pasty media, various applications, in which the hollow bodies are electrically heatable, are known. In this way, a predetermined temperature can be reached for example during transport and/or during storage. Furthermore, this is important in particular when media are intended to be transported and/or stored in the hollow bodies, where there is a risk of said media being able to freeze during use, thereby possibly preventing transport through the hollow body or evacuation from the hollow body. This relates for example to hoses for transporting water or aqueous media. For applications for transporting and/or storing highly viscous media, for example oils, too, it may be sensible to reduce the viscosity of the medium by heating the medium and thus to make it easier to transport the medium.

The described technical solutions in this regard are generally based on the integration of heating conductors in the form of resistance heating conductors into the structure of the hollow bodies.

DE 10 2012 002 411 A1 relates to a heatable media line and describes a hose structure having a heating element made of resistance wires.

EP 1 329 660 A2 relates to a flexible, multilayer, heatable hose in the field of SCR (selective catalytic reduction) hose technology, having a spooled-in resistance heating conductor above the reinforcement layer and beneath the outer rubber layer.

DE 10 2009 003 394 A1 relates to a heatable article, in particular a heatable hose in the field of SCR hose technology, having a heating conductor sheathed in plastics material and a method for the production thereof. The wires used therein have sheathings based on polyphenylene plastics materials.

DE 199 15 228 A1 relates to a heatable hose for a motor-vehicle brake device, having a pressure hose with an integrated heating conductor.

A disadvantage with the above-described heatable articles is that the heat is at all times not distributed evenly over the wall of the hollow body but rather is much higher locally in the vicinity of the heating conductor than in the surrounding regions of the wall. Furthermore, the heat output is defined via the resistance of the heating conductors, i.e. the heating system is very sensitive to all influences on the specific resistance of the heating conductors, and since the heat output would thus change in operation. Moreover, the complexity for protecting the heating conductors specifically against corrosion phenomena is very high. For this purpose, provision can be made of specific sheathings for the heating conductors, which must not be damaged even during the production process. Specifically for ensuring the intact heating-conductor sheathing, very complicated process monitoring steps are required, for example spark tests, which also influence the material specifications of the layers of the hollow body (for example the conductivity requirements placed on the individual rubber layers of a hose).

DE 10 2010 051 550 A1 relates to a prefabricated electrically heatable media line having at least one pipeline part with an integrated electrically conductive device in the form of either heating conductors embedded in the pipe wall or electrical conductors embedded in conductive material that is provided in the pipe wall. In the case of an embedded heating conductor, the heat source for heating the pipeline part is the heating conductor itself, and in the case of the electrical conductors embedded in conductive material, the heat source is the conductive material through which electrical current flows between the electrical conductors that then act as poles. In the latter case, a middle layer of the pipeline part can consist of a plastics material filled with at least one conductive component, in particular of a plastics material filled with conductive carbon black, metal powder or carbon nanotubes.

A disadvantage of all the above-described solutions is that the known heatable hollow bodies always have poor thermal efficiency. The reason for this is that the heating conductors or the heating layer tend to be arranged in the middle of the wall of the hollow bodies and are thus arranged relatively far away from the medium to be heated. For example, the heating conductors or the heating layer is generally arranged above the outermost reinforcement layer in hoses. As a result, it is difficult to transport the electrically generated heat to the medium inside the hollow body. Large heat losses arise, because a substantial proportion of the electrically generated heat is transported outward to the wall and is emitted to the surroundings there without heating the medium.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

It is an object of the present invention to improve the thermal efficiency of an electrically heatable hollow body of the type described at the beginning, but at the least to provide alternatives to the known electrically heatable hollow bodies.

In a first aspect, a heatable hollow body for transporting and/or storing liquid, gaseous and/or pasty media, having at least one heatable layer which has an electrically conductive material, is provided, wherein the heatable layer is in direct contact at least partially, preferably largely, particularly preferably fully, with the medium to be heated. In some aspects, the electrically conductive material has such a high electrical resistance that it can heat the heatable layer as a resistance conductor, and the electrically conductive material has such a low electrical resistance that the heatable layer is simultaneously electrically conductive. In some cases, the heatable layer has an elastomeric material or a plastics material in which the electrically conductive material is embedded. Also, the electrically conductive material may be conductive carbon black, a metal powder or carbon nanotubes.

In another aspect, a system for electrically heating liquid, gaseous and/or pasty media, having a heatable hollow body as described above is provided, and further includes a voltage source, preferably a DC voltage source, which is connected to the first electrical conductor and to a second electrical conductor in an electrically conductive manner.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 shows a perspective schematic illustration of a heatable hollow body in the form of a heatable hose according to a first exemplary embodiment;

FIG. 2 shows a perspective schematic illustration of a heatable hollow body in the form of a heatable hose according to a second exemplary embodiment; and,

FIG. 3 shows a system for electrical heating with a heatable hose according to the first exemplary embodiment.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure.

The present invention relates to a heatable hollow body for transporting and/or storing liquid, gaseous and/or pasty media, having at least one heatable layer which has an electrically conductive material. The heatable hollow body is characterized in that the heatable layer is in direct contact at least partially, preferably largely, particularly preferably fully, with the medium to be heated. The invention is based on the discovery of using an entire layer of the hollow body instead of the previously conventional line-form heating wires to heat the medium, in order to achieve heat generation and propagation that is as extensive and even as possible, and at the same time to bring this heating layer into direct contact with the medium to be heated. As a result, the heat is discharged to the medium more quickly, more uniformly and with fewer losses, with the result that the heating can be set or regulated more easily and more directly and electrical energy can be saved.

According to one aspect of the invention, the electrically conductive material has such a high electrical resistance that it can heat the heatable layer as a resistance conductor, and the electrically conductive material has such a low electrical resistance that the heatable layer is simultaneously electrically conductive. This balance between electrical conductivity and electrical resistance can be set via the specific resistance of the material through the choice of the corresponding constituents or the proportions thereof in the composition of the material. In this case, given sufficient electrical power loss in the heatable layer, there has to be a flow of the electrical current through the electrically conductive material.

According to a further aspect of the invention, the heatable layer has an elastomeric material or a plastics material in which the electrically conductive material is embedded. In this way, the hollow body can be provided for example as a hose made of an elastomer material, for example rubber, in order to make it for example flexible, pliable and/or extendable, or of plastics material for example as a media tank with a low weight. The electrical conductivity with simultaneous generation of electrical heat losses can take place via corresponding additions of electrically conductive constituents into the rubber or plastics material.

According to a further aspect of the invention, the electrically conductive material is a conductive carbon black or a metal powder or carbon nanotubes. Such constituents can be processed and metered easily and reliably in order to reliably achieve the desired electrical conductivity with simultaneously desired electrical resistance. In the case of heatable layers made of rubber, all conductive elastomer mixtures are conceivable in principle, but carbon-black-filled elastomer mixtures have been found to be particularly advantageous, since these have a comparatively high heat loss rate during the conduction of the electrical current and can be set to a suitable material-intrinsic, i.e. specific resistance.

According to a further aspect of the invention, the heatable hollow body has a first electrical conductor which is connected to the heatable layer in an electrically conductive manner, and a second electrical conductor which is connected to the heatable layer in an electrically conductive manner, wherein the first electrical conductor and the second electrical conductor have a low electrical resistance. Via these electrical conductors, the heatable layer can be connected to a voltage source in order to supply it with the electrical heat output. According to the invention, the electrical conductors do not themselves serve here as heating resistors but as electrodes, and therefore have an electrical conductivity that is as high as possible in order to supply the electrical current to the electrically conductive material of the heatable layer in a manner as free of losses as possible, i.e. to allow as much voltage as possible to drop across the electrically conductive material of the heatable layer. Therefore, the electrodes have or consist of a readily conductive material. This electrode material has to be stable with regard to the constituents of the heatable layer, for example the rubber or plastics constituents thereof, and with respect to the production process for the heatable hollow body.

To this end it is possible to use for example metal electrodes made for example of copper. It is advantageous here for metal electrodes to be conveniently available and easy to process. Furthermore, metal electrodes are not as sensitive to relatively small material changes as when they are used as heating conductors. Thus, a small amount of corrosion is insignificant for the functioning of the electrodes, in contrast to the heating conductors. Therefore, the electrodes according to the invention also do not have to be additionally sheathed and protected, thereby simplifying production and making it cheaper. Also, according to the invention, no electrically insulating sheathing at all may be provided about the electrodes, at least not at those locations at which they are intended to be in electrically conductive contact with the heatable layer, because said contact would be prevented by the sheathing.

According to a further aspect of the invention, the first electrical conductor and/or the second electrical conductor has or have an electrically conductive nonmetallic material. This means that the electrodes, as conductive yarns or wires, have for example carbon fibres, conductive polymer yarns, conductive textile yarns and conductive modified rubber mixtures, or can consist thereof.

According to a further aspect of the invention, the heatable hollow body is a heatable hose, and the first electrical conductor and the second electrical conductor are arranged helically at a constant distance apart in the circumferential direction on that side of the heatable layer that is remote from the medium to be heated. This has the advantage that the electrodes are protected from the medium both mechanically and chemically by the heatable layer. Furthermore, the electrodes can be attached to the heatable layer from the outside, thereby simplifying production. It is also possible for the electrodes to be incorporated in possible further outer layers of the hose, or be fixed and protected thereby.

The combination of an electrically conductive heatable layer with an electrode system has the result that with a correspondingly selected resistance ratio between electrodes and electrically conductive material, the charge carriers are distributed evenly along the entire coil length of the electrode and only the short distance between the two electrodes has to be overcome in a then virtually homogeneous electrical field. This is highly advantageous especially in combination with conductive elastomer layers, because at spacings of for example a few millimeters to centimeters, significant current strengths and, associated therewith, also heat loss rates can be generated quite easily at moderate voltages. Thus, through the combination of the parameters of specific resistance of the heating layer, specific resistance of the electrodes, spacing apart of the electrodes and applied voltage, a suitable combination can be found for virtually any application.

A great advantage of this aspect of the invention is also that the length of the heatable hose scarcely has any influence on the functioning of the invention. The applied voltage and the resulting heat output are relatively independent of the length of the spooled-in electrodes. This makes it possible to apply the invention without a great deal of effort in adapting it to a multiplicity of different hose lengths. In this case, the same heatable layer having the same electrode parameters (spacing, coiling parameter) can be used for many applications.

According to a further aspect of the invention, the first electrical conductor has a contact connection at one end of the heatable hose, and the second electrical conductor has a contact connection at the opposite end of the heatable hose. In principle, in a heatable hose, there are the possible variations of connecting the two electrodes to the same hose end with the voltage source, resulting in current transfer in the same direction, or to provide one of the two electrodes at in each case one hose end, meaning current conduction in opposite directions. This has an influence on the distribution of the heat development along the hose length. In this case, the approach of making contact at each of the two ends advantageously results in homogeneous heat distribution, whereas a gradient can be achieved by means of current conduction in opposite directions. In this case, the relationship of the specific resistance of the electrode material to the electrical resistance of the heatable layer plays a role. Since the current has to be uniformly available along the entire hose length, this requires an electrode resistance that is as low as possible with regard to the resistance of the heatable layer. This is also advantageous because more voltage then drops across the heatable layer and the electrical work can be dissipated in heat.

According to a further aspect of the invention, the heatable hollow body has a multilayer wall, the innermost layer of which is the heatable layer, wherein the wall furthermore has a reinforcement layer which is arranged on that side of the heatable layer that is remote from the medium to be heated. In this way, the stability of the heatable hollow body can be reinforced if this is desired or to the degree that this is desired. Warp-knitted fabrics, braided fabrics and/or knitted fabrics can be used as reinforcement layer.

According to a further aspect of the invention, the first electrical conductor and/or the second electrical conductor is or are contained in the reinforcement layer. As a result, the position of the electrodes with respect to the surface of the heatable layer and regular contact of the electrodes with the heatable layer can be ensured.

The invention also relates to a system for electrically heating liquid, gaseous and/or pasty media, having a heatable hollow body as described above, and a voltage source, preferably a DC voltage source, which is connected to the first electrical conductor and to the second electrical conductor in an electrically conductive manner. The heatable layer can be energized via the electrodes in principle such that energization takes place with DC voltage or with AC voltage. The approach with DC voltage has been found to be advantageous since fewer electrical fields are emitted, this being advantageous for example for the use of the heatable hollow body according to the invention in motor vehicles.

Two exemplary embodiments and further advantages of the invention are explained in the following text in conjunction with the figures.

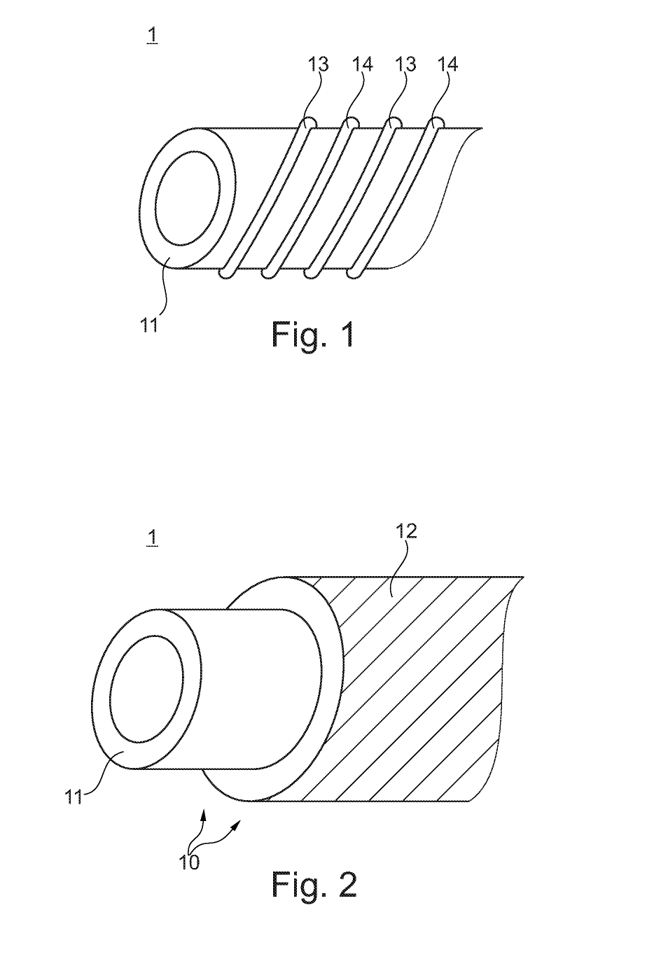

FIG. 1 shows a perspective schematic illustration of a heatable hollow body 1 in the form of a heatable hose 1 according to a first exemplary embodiment. The heatable hose 1 has a heatable layer 11 which is the innermost layer 11 of its wall structure and as a result is in direct contact fully with the medium to be heated inside the heatable hose 1. Around this heatable innermost layer 11, further layers (not illustrated) can be provided. A pair of electrodes 13, 14 in the form of a first electrical conductor 13 and a second electrical conductor 14 are arranged on the heatable layer 11 such that said electrodes are connected extensively together in an electrically conductive manner via an electrically conductive material, for example conductive carbon black, metal powder or carbon nanotubes. If a voltage is now applied to the electrodes 13, 14, the current heat losses in the electrically conductive material lead, via the thus heated innermost layer 11 of the hose 1, to direct heating of the medium inside the heatable hose 1.

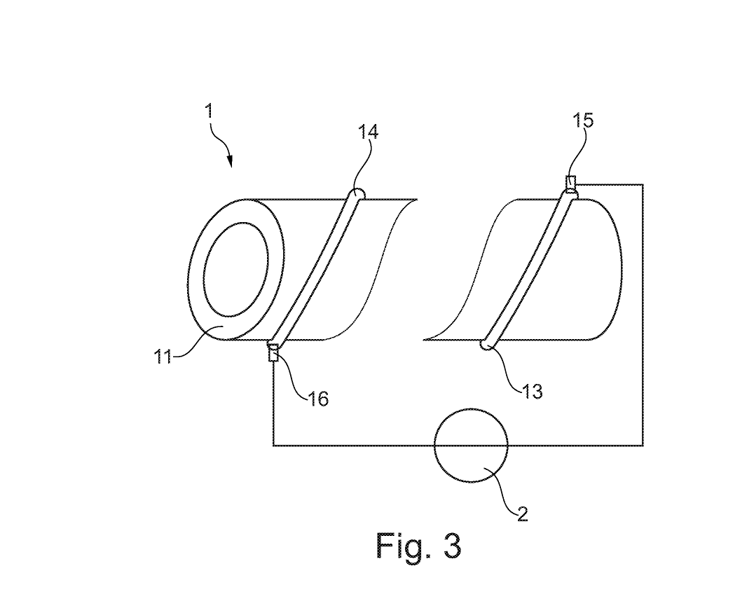

FIG. 2 shows a perspective schematic illustration of a heatable hollow body 1 in the form of a heatable hose 1 according to a second exemplary embodiment. In this case, the two electrodes 13, 14 (not illustrated) are integrated inside a reinforcement layer 12 of a multilayer wall 10 of the heatable hose 1.

FIG. 3 shows a system for electrical heating with a heatable hose 1 according to the first exemplary embodiment. To this end, the two electrodes 13, 14 are each connected in an electrically conductive manner via a contact connection 15, 16 to a voltage source 2, which is preferably a DC voltage source 2.

### LIST OF REFERENCE SIGNS (PART OF THE DESCRIPTION)

1 Heatable hollow body, preferably heatable hose
10 Multilayer wall of the heatable hollow body 1
11 Heatable layer, innermost layer of the heatable hollow body 1
12 Reinforcement layer
13 First electrical conductor, first electrode
14 Second electrical conductor, second electrode
15 Contact connection of the first electrical conductor 13
16 Contact connection of the second electrical conductor 14
2 (DC) voltage source

We claim:

1. A heatable hollow body for transporting and/or storing liquid, gaseous and/or pasty media, the heatable hollow body comprising at least one heatable layer comprising an electrically conductive material, wherein the heatable layer is in direct contact at least partially with the media to heat the media.

2. The heatable hollow body as claimed in claim 1, wherein the electrically conductive material has such a high electrical resistance that it can heat the heatable layer as a resistance conductor, and wherein the electrically conductive material has such a low electrical resistance that the heatable layer is simultaneously electrically conductive.

3. The heatable hollow body as claimed in claim 1, wherein the heatable layer comprises an elastomeric material or a plastics material in which the electrically conductive material is embedded.

4. The heatable hollow body as claimed in claim 1, wherein the electrically conductive material is conductive carbon black, a metal powder or carbon nanotubes.

5. The heatable hollow body as claimed in claim 1, further comprising a first electrical conductor connected to the heatable layer in an electrically conductive manner, and a second electrical conductor connected to the heatable layer in an electrically conductive manner, wherein the first electrical conductor and the second electrical conductor have a low electrical resistance.

6. The heatable hollow body as claimed in claim 5, wherein the first electrical conductor and/or the second electrical conductor comprise(s) an electrically conductive nonmetallic material.

7. The heatable hollow body as claimed in claim 5, wherein the heatable hollow body is a heatable hose, and wherein the first electrical conductor and the second electrical conductor are arranged helically at a constant distance apart in the circumferential direction on that side of the heatable layer that is remote from the medium to be heated.

8. The heatable hollow body as claimed in claim 7, wherein the first electrical conductor has a contact connection at one end of the heatable hose, and
wherein the second electrical conductor has a contact connection at the opposite end of the heatable hose.

9. The heatable hollow body as claimed in claim 1, wherein the heatable hollow body further comprises a multilayer wall, and the innermost layer of the multilayer wall is the heatable layer, wherein the wall further comprises a reinforcement layer arranged on that side of the heatable layer remote from the medium to be heated.

10. The heatable hollow body as claimed in claim 9, wherein a first electrical conductor and/or a second electrical conductor is or are contained in the reinforcement layer.

11. A system for electrically heating liquid, gaseous and/or pasty media, having
a heatable hollow body as claimed in claim 1, wherein the system further comprises a voltage source connected to a first electrical conductor and to a second electrical conductor in an electrically conductive manner.

12. A heatable hollow hose for transporting and/or storing liquid, gaseous and/or pasty media, the heatable hollow body comprising at least one heatable layer comprising an electrically conductive material, wherein the heatable layer is in direct contact at least partially with the media to heat the media;
the heatable hollow body further comprising a first electrical conductor connected to the heatable layer in an electrically conductive manner, and a second electrical conductor connected to the heatable layer in an electrically conductive manner,
wherein the first electrical conductor and the second electrical conductor have a low electrical resistance, and wherein the first electrical conductor and the second electrical conductor are arranged helically at a constant distance apart in the circumferential direction on that side of the heatable layer that is remote from the medium to be heated; and,
wherein the first electrical conductor has a contact connection at one end of the heatable hose, and the second electrical conductor has a contact connection at the opposite end of the heatable hose.

13. The heatable hollow hose as claimed in claim 12, wherein the electrically conductive material has such a high electrical resistance that it can heat the heatable layer as a resistance conductor, and wherein the electrically conductive material has such a low electrical resistance that the heatable layer is simultaneously electrically conductive.

14. The heatable hollow hose as claimed in claim 12, wherein the heatable layer comprises an elastomeric material or a plastics material in which the electrically conductive material is embedded.

15. The heatable hollow hose as claimed in claim 12, wherein the electrically conductive material is conductive carbon black, a metal powder or carbon nanotubes.

16. The heatable hollow hose as claimed in claim 12, wherein the heatable hollow hose further comprises a multilayer wall, and the innermost layer of the multilayer wall is the heatable layer, wherein the wall further comprises a reinforcement layer arranged on that side of the heatable layer remote from the medium to be heated, and wherein a first electrical conductor and/or a second electrical conductor is or are contained in the reinforcement layer.

17. A heatable hollow body for transporting and/or storing liquid, gaseous and/or pasty media, the heatable hollow body comprising at least one heatable layer comprising an electrically conductive material, wherein the heatable layer is in direct contact at least partially with the media to heat the media;
wherein the heatable hollow body further comprises a multilayer wall, and the innermost layer of the multilayer wall is the heatable layer, wherein the wall further comprises a reinforcement layer arranged on that side of the heatable layer remote from the medium to be heated; and,
wherein a first electrical conductor and/or a second electrical conductor is or are contained in the reinforcement layer.

18. The heatable hollow body as claimed in claim 17, wherein the electrically conductive material has such a high electrical resistance that it can heat the heatable layer as a resistance conductor, and wherein the electrically conductive material has such a low electrical resistance that the heatable layer is simultaneously electrically conductive.

19. The heatable hollow body as claimed in claim 17, wherein the heatable layer comprises an elastomeric material or a plastics material in which the electrically conductive material is embedded.

20. The heatable hollow body as claimed in claim 17, wherein the electrically conductive material is conductive carbon black, a metal powder or carbon nanotubes.
